(19) United States
(12) Patent Application Publication
(10) Pub. No.: US 2026/0123587 A1
(43) Pub. Date: May 7, 2026

(54) WALK-BEHIND BLOWER

(71) Applicant: Milwaukee Electric Tool Corporation, Brookfield, WI (US)

(72) Inventors: Michael S. Van Dyke, Wauwatosa, WI (US); Austin F. De Veer, Brookfield, WI (US); Bradford A. Gill, Brookfield, WI (US); Adam F. Czerwonka, Mukwonago, WI (US); Seamus J. D. Herson, Wauwatosa, WI (US); Shreyas Sidar, Brookfield, WI (US); Devlin N. Thyne, Milwaukee, WI (US); Adam M. Lason, Brookfield, WI (US); Michael J. Caelwaerts, Menomonee Falls, WI (US); Brady C. Hawks, Brookfield, WI (US); Joseph S. Wilinski, Jr., Wauwatosa, WI (US); Marcus T. Jenkins, Wauwatosa, WI (US); Katherine G. Stringfield, Wauwatosa, WI (US); John S. Scott, Brookfield, WI (US)

(21) Appl. No.: 19/354,223

(22) Filed: Oct. 9, 2025

Related U.S. Application Data
(60) Provisional application No. 63/705,138, filed on Oct. 9, 2024.

(51) Int. Cl. A01G 20/47

(52) U.S. Cl. CPC A01G 20/47

(57) ABSTRACT

A walk-behind blower includes a frame, one or more movable elements, a housing, and a fan assembly. The one or more movable elements are mounted to the frame to movably support the frame. The housing is supported on the frame. The housing defines an airflow conduit extending therethrough between a first end and a second end. At least a portion of the housing is movable relative to the frame to selectively redirect an airflow from the airflow conduit. The fan assembly is disposed between the first end and the second end to motivate the airflow through the airflow conduit.

### CROSS-REFERENCE TO RELATED APPLICATIONS

The present application claims priority to U.S. Provisional Patent Application No. 63/705,138 filed on Oct. 9, 2024, the disclosure of which is incorporated by reference herein in its entirety.

### FIELD

The present disclosure relates generally to outdoor power equipment, and more particularly to improved debris collection tools, such as for collection of leaves and other outdoor debris.

### BACKGROUND

Improved performance, durability, and/or longevity in outdoor power equipment, especially in debris collection tools, is desired. For instance, blower tools have long been used to move large volumes of debris, particularly leaves, in order to clear property. This may require significant amounts of force to propel the leaves. In the case of hand-held or backpack blower tools, it may be difficult to provide a tool capable of reaching suitable power levels, particularly one that is not unwieldy, cumbersome, or expensive for many users. Some walk-behind blower tools exist to help mitigate such problems. Existing tools typically rely on an internal combustion engine, which may power rotation of a centrifugal fan. Often, such tools are still noisy, inefficient, or difficult to maneuver. Additionally or alternatively, existing tools may be especially difficult to control. In particular, many existing walk-behind blowers include a fixed or predetermined direction of output. In turn, a user may be required to awkwardly or uncomfortably manipulate the entire blower.

Accordingly, improvements which address the above-described issues are desired in the art and would be advantageous. For instance, it may be advantageous to provide walk-behind blower able to deliver significant blower force (e.g., in a relatively compact profile). Additionally or alternatively, an easily maneuverable walk-behind blower may be useful.

### BRIEF DESCRIPTION

Aspects and advantages of the present disclosure will be set forth in part in the following description, or may be obvious from the description, or may be learned through practice of the technology.

In accordance with one embodiment, a walk-behind blower is provided. The walk-behind blower may include a frame, one or more movable elements, a housing, and a fan assembly. The one or more movable elements may be mounted to the frame to movably support the frame. The housing may be supported on the frame. The housing may define an airflow conduit extending therethrough between a first end and a second end. At least a portion of the housing may be movable relative to the frame to selectively redirect an airflow from the airflow conduit. The fan assembly may be disposed between the first end and the second end to motivate the airflow through the airflow conduit.

In accordance with another embodiment, a walk-behind blower is provided. The walk-behind blower may include a frame, one or more movable elements, a housing, a propulsion motor, a fan assembly, a positional motor, and a plurality of batteries. The one or more movable elements may be mounted to the frame to movably support the frame. The housing may be supported on the frame. The housing may define an airflow conduit extending therethrough between a first end and a second end. At least a portion of the housing may be movable relative to the frame to selectively redirect an airflow from the airflow conduit. The propulsion motor may be in mechanical communication with the one or more movable elements to motivate travel of the walk-behind blower. The fan assembly may be disposed between the first end and the second end to motivate the airflow through the airflow conduit. The positional motor may be attached to the housing in mechanical communication with the housing to selectively redirect the air conduit according to a directional input signal. The plurality of batteries may be attached to the frame in electric communication with the propulsion motor, the fan assembly, and the positional motor.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 provides a perspective view of a walk-behind blower in accordance with embodiments of the present disclosure;

FIG. 2 provides a perspective view of a fan assembly and housing of the exemplary walk-behind blower of FIG. 1;

FIG. 3 provides a perspective view of the exemplary fan assembly and housing of FIG. 2, wherein a cross-sectional portion of the fan assembly has been removed for clarity;

FIG. 4 provides a perspective view of a walk-behind blower in accordance with other embodiments of the present disclosure;

FIG. 5 provides a perspective view of still a walk-behind blower in accordance with still other embodiments of the present disclosure;

FIG. 6 provides a perspective view of a user interface of a walk-behind blower in accordance with embodiments of the present disclosure;

FIG. 7A provides a simplified schematic view of a wheel arrangement of a walk-behind blower in accordance with embodiments of the present disclosure;

FIG. 7B provides a simplified schematic view of another wheel arrangement of a walk-behind blower in accordance with embodiments of the present disclosure;

FIG. 7C provides a simplified schematic view of yet another wheel arrangement of a walk-behind blower in accordance with embodiments of the present disclosure;

FIG. 7D provides a simplified schematic view of still another wheel arrangement of a walk-behind blower in accordance with embodiments of the present disclosure;

FIG. 8A provides a perspective view of a walk-behind blower in accordance with other embodiments of the present disclosure;

FIG. 8B provides a perspective view of a walk-behind blower in accordance with yet other embodiments of the present disclosure;

FIG. 9 provides a perspective view of a walk-behind blower in accordance with other embodiments of the present disclosure;

FIG. 10 provides a perspective view of an interchangeable assembly, including multiple connecting frames or vehicles, for a walk-behind blower in accordance with embodiments of the present disclosure;

FIG. 11 provides a perspective view of a fan assembly and housing of a walk-behind blower in accordance with embodiments of the present disclosure;

FIG. 12 provides a simplified schematic view of a walk-behind blower in accordance with embodiments of the present disclosure;

FIG. 13 provides a simplified schematic view of a walk-behind blower and selectively attachable hand-held blower in accordance with embodiments of the present disclosure;

FIG. 14 provides a simplified schematic view of a walk-behind blower in accordance with embodiments of the present disclosure;

FIG. 15A provides a simplified schematic view of a walk-behind blower in accordance with embodiments of the present disclosure, wherein a handle assembly is illustrated as moving between a first position and a second position;

FIG. 15B provides a simplified schematic view of a walk-behind blower in accordance with other embodiments of the present disclosure, wherein a handle assembly is positioned in a first position;

FIG. 15C provides a simplified schematic view of the exemplary walk-behind blower of FIG. 15B, wherein a handle assembly is positioned in a second position;

FIG. 16A provides a simplified perspective view of a walk-behind blower in accordance with embodiments of the present disclosure, wherein the walk-behind blower is provided in an extended position;

FIG. 16B provides a perspective view of a walk-behind blower in accordance with other embodiments of the present disclosure, wherein the walk-behind blower is provided in an extended position;

FIG. 16C provides a perspective view of the exemplary walk-behind blower of FIG. 16B, wherein a handle assembly is positioned in a folded position;

FIG. 17 provides a simplified schematic view of a walk-behind blower in accordance with embodiments of the present disclosure.

FIG. 18 provides a simplified perspective view of a walk-behind blower in accordance with embodiments of the present disclosure;

FIG. 19 provides a simplified perspective view illustrating a method of operating a walk-behind blower in accordance with embodiments of the present disclosure; and

FIG. 20 provides a simplified perspective view illustrating another method of operating a walk-behind blower in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure provides a user-friendly walk-behind blower. Such a blower may include a fan assembly having an air outlet or exhaust that may be advantageously moved or repositioned (e.g., relative to a frame on which the fan assembly is supported). Notably, the blower can be easily manipulated such that the direction of airflow from the outlet or exhaust is changed according to the preference, needs, or other specified criteria of the user.

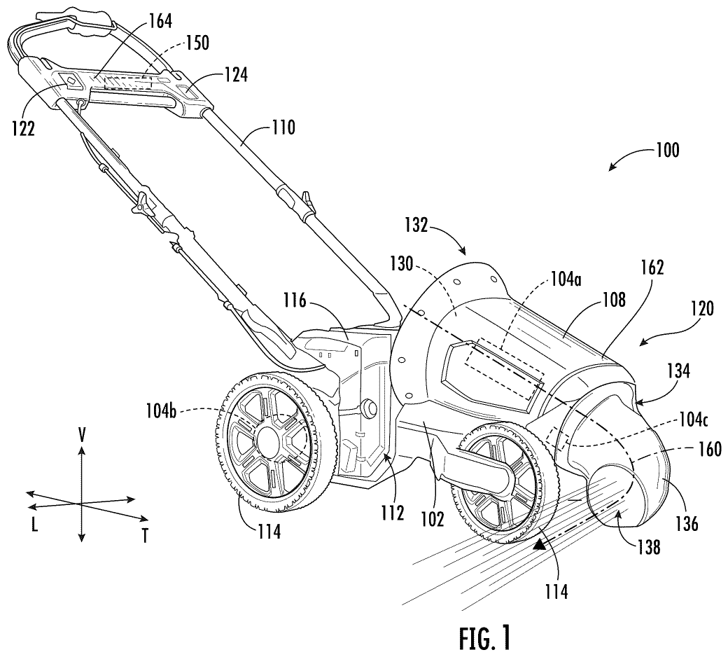

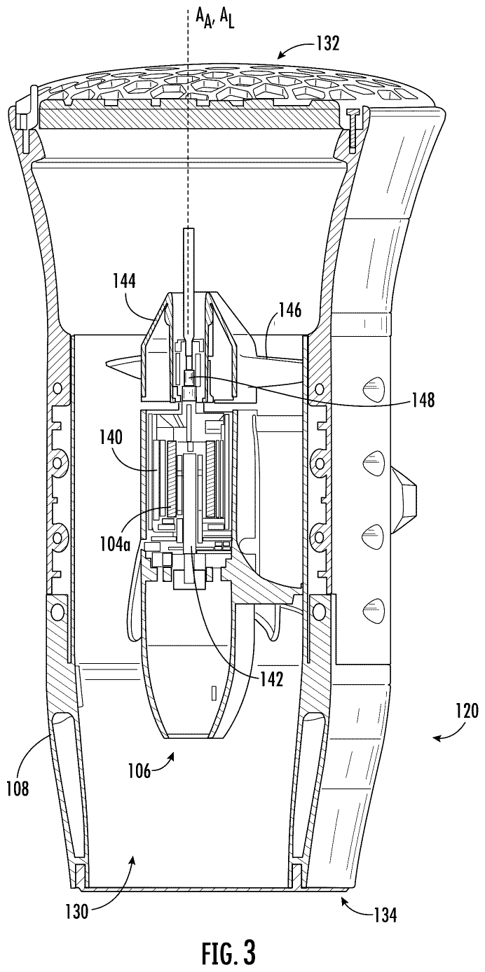

Referring now to the drawings, FIG. 1 illustrates a perspective view of a walk-behind blower 100 in accordance with various exemplary embodiments of the present disclosure. Generally, walk-behind blower 100 defines a mutually orthogonal vertical direction V, lateral direction L, and transverse direction T. The walk-behind blower 100 includes a frame 102, one or more motors 104 (e.g., fan motor 104a, propulsion motor 104b, or positional motor 104c), and a fan assembly 120. The fan assembly 120 may include an axial or blower fan 106 (FIG. 3) that is coupled or attached (e.g., rotatably mounted) to the frame 102 (e.g., disposed in fan housing 108) to rotate about a defined motor axis A_{A}.

As shown, the fan housing 108 may be supported on (e.g., mounted to) the frame 102 and defines an airflow conduit 130 that extends (e.g., along a longitudinal axis A_{L}) between a first end 132 (e.g., air inlet end) and a second end 134 (e.g., air outlet end). An axial length is defined from the first end 132 to the second end 134. In some embodiments, the axial length may be between 10 inches and 20 inches (e.g., between 12 inches and 16 inches).

The walk-behind blower 100 is generally configured to generate airflow along the airflow conduit 130 extending between the first end 132, e.g., air inlet, and the second end 134, e.g., air outlet, of the walk-behind blower 100. The airflow conduit 130 may include a tube as shown. As will be described in greater detail below, at least a portion of the housing 108 being movable relative to the frame 102 to selectively redirect an airflow from the airflow conduit 130.

Turning now generally to FIGS. 1 through 3, FIGS. 2 and 3 provide a perspective view of a fan assembly 120 of the walk-behind blower 100 according to exemplary embodiments. As illustrated, a housing 108, e.g., a main body of the walk-behind blower 100, may at least partially enclose components of the walk-behind blower 100 such as an airflow generation assembly 120 including a fan 106 and a motor 104a that drives the fan 106, as well as various other components. For instance, airflow generation assembly 120 may be disposed between the first end 132 and the second end 134 of the airflow conduit 130.

Walk-behind blower 100 may further include a handle assembly 110 extending from the frame 102. As illustrated, the handle assembly 110 can extend from a rear end of the frame 102 in a generally vertical direction V. As will be described in greater detail below, the handle assembly 110 may include one or more controls (e.g., 122 or 124) associated with controlling operational aspect(s) of the walk-behind blower 100. A battery compartment 112 can be attached to the frame 102 (e.g., apart or rearward from the first end 132) to receive one or more batteries or battery packs 116, which can provide power to the one or more motors 104a, 104b, 104c (e.g., one more electric motors). Thus, one or more of the motors 104a, 104b, 104c may be in electrical communication with the battery pack 116 to receive an electrical current therefrom, such as to motivate rotation of the fan 106 or walking elements 114.

The frame 102, or walk-behind blower 100 generally, is supported by one or more walking elements 114 (e.g., wheels or continuous track treads). In some embodiments, the walking elements 114 include one or more forward walking elements 114 and one or more rear walking elements 114. In certain embodiments, one or more walking elements 114 (e.g., rear walking elements 114) define a wheel axis (e.g., parallel to the lateral direction L) about which the elements or wheels 114 rotate. The rear walking element(s) 114 may be disposed rearward from the first end 132. Additionally or alternatively, the front walking elements 114 may be disposed (e.g., partially or fully) forward from the first end 132 and, optionally, rearward from the second end 134 (e.g., at the wheel axis of the front walking element(s) 114).

In optional embodiments, the wheels 114 include a pair of driven wheels that can be driven or rotated by a discrete propulsion motor 104b (e.g., separate from fan motor 104a). As illustrated, the propulsion motor 104b may be supported on the frame 102 apart from the fan motor 104a. Although the driven wheels 114 may be motivated or rotated by propulsion motor 104b, an operator or user may selectively push the walk-behind blower 100 (e.g., manually).

In some embodiments, a controller 150 may be provided in operative communication with one or more components of walk-behind blower 100 (e.g., motors 104a, 104b, etc.). The controller 150 may include a memory and one or more microprocessors, CPUs or the like, such as general or special purpose microprocessors operable to execute programming instructions or micro-control code associated with operation of walk-behind blower 100. The memory may represent random access memory such as DRAM, or read only memory such as ROM or FLASH. In some embodiments, the processor executes non-transitory programming instructions stored in memory. For certain embodiments, the instructions include a software package configured to operate walk-behind blower 100 or execute an operation routine (e.g., as described below). The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout walk-behind blower 100. Input/output (“I/O”) signals may be routed between controller 150 and various operational components of walk-behind blower 100. One or more components of walk-behind blower 100 may be in operative communication (e.g., electric communication) with controller 150 via one or more conductive signal lines or shared communication busses.

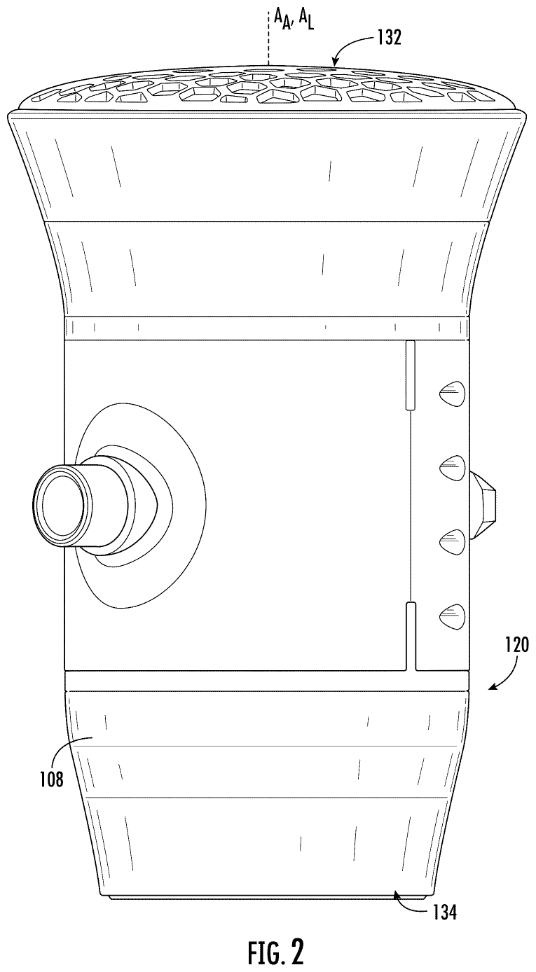

Referring especially to FIGS. 2 and 3, the fan assembly 120 may have an axial configuration including an axial fan 106. The motor 104a may be mounted within the housing 108. For instance, the housing 108 may include a motor mount 140 configured to support the motor 104a between the first end 132 and the second end 134. The motor 104a is oriented along a motor axis A_{A}. In some embodiments, the motor axis A_{A} coincides with a longitudinal axis A_{L} of the airflow conduit 130. Rotation of the motor 104a causes rotation of a primary motor shaft 142 extending along the motor axis A_{A}. The motor shaft 142 is coupled to the fan 106 (e.g., rotatably connected to the fan 106). In this manner, rotation of the motor shaft 142 causes rotation of the fan 106. The motor 104a may be configured to operate at a rotational speed in a range from about 21000 rotations per minute (RPM) to about 38000 RPM.

In some embodiments, fan 106 includes a hub 144 and a plurality of blades 146. The hub 144 may have a generally circular cross-sectional shape and may extend along the motor axis A_{A}. The motor shaft 142 is coupled to the hub 144 or a fan drive shaft 148 to enable transmission of rotation from the motor 104a to the hub 144 or the fan drive shaft 148 and ultimately to the blades 146.

Generally, each respective fan blade 146 extends radially away from the hub 144. Each blade 146 extends from a root and terminates at a tip end, and has a first face and a second face opposite the first face. The root contacts the hub 144 of the fan 106.

Optionally, the fan assembly 120 may be optimized when a dimensionless flow coefficient Φ is in a range from about 0.2 to about 0.6. The size and speed of the fan assembly 120 are defined as a function of the optimal flow coefficient Φ. The flow coefficient is calculated by the following equation:

$$Φ = \frac{q / ( A )}{ω R}$$

where q represents flow (m³/s), A represents cross sectional area at the fan (m²), ω represents speed (rad/s) and R represents fan tip radius (m) measured at a blade tip. Stated differently, the numerator q/(A) is the axial velocity of the fan (meters per second).

Based on the calculation of the flow coefficient Φ as shown above, the optimal size of the fan may be determined by rearranging the equation as shown below:

$$R = \frac{q / ( A )}{ω {Φ}_{i d e a l}}$$

By optimizing both the blade solidity and the flow coefficient of the fan assembly 120 during operation of the walk-behind blower 100, the present inventors have found that the walk-behind blower 100 may generate less audible noise while maintaining optimal airflow characteristics, thereby improving the user's overall experience during operation of the walk-behind blower 100. For instance, reducing the audible noise generated by the walk-behind blower 100 may be highly desirable to users, particularly for homeowners and other non-professional users. Simultaneously, maintaining optimal airflow characteristics may enable efficient battery life of the walk-behind blower 100, reducing the need for users to recharge or replace the power source without reducing the power of the airflow generated during operation. Additionally or alternatively, blower 100 may have significantly higher air flow than known blowers.

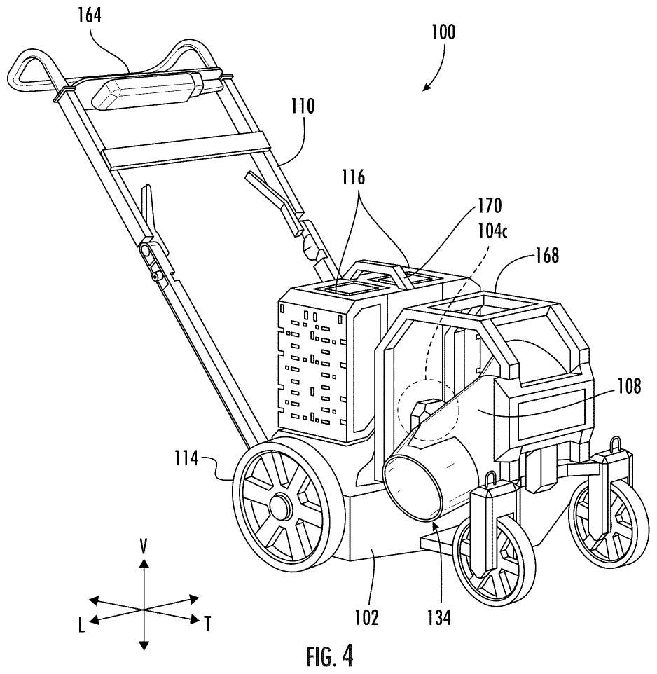

Turning now generally to FIG. 1, as well as FIGS. 4, 5, 8A, 8B, 9, and 12, at least a portion of the housing 108 may be movable relative to the frame 102. In particular, one or more portions defining the airflow path 160 through the housing 108 may be movable or adjustable to selectively redirect the airflow from the airflow conduit 130.

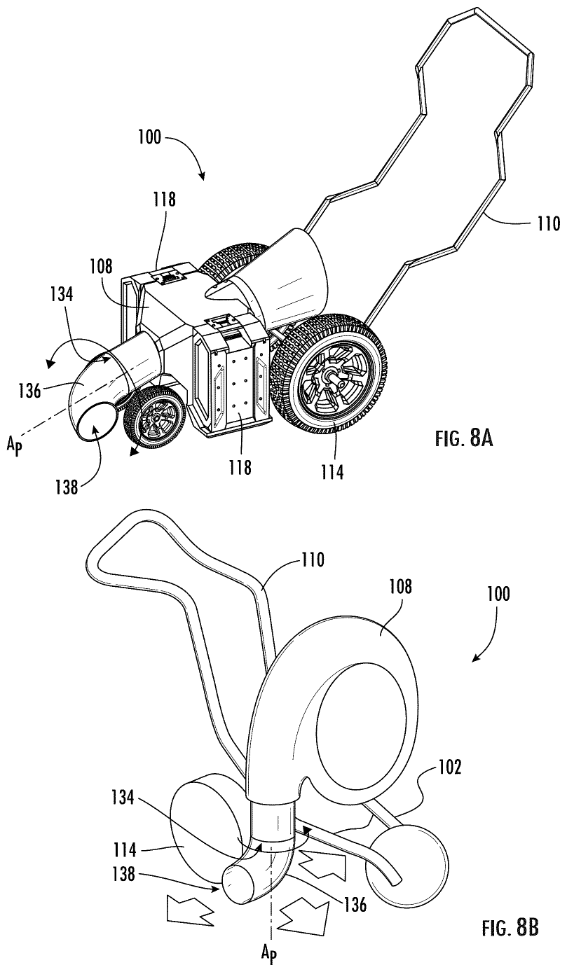

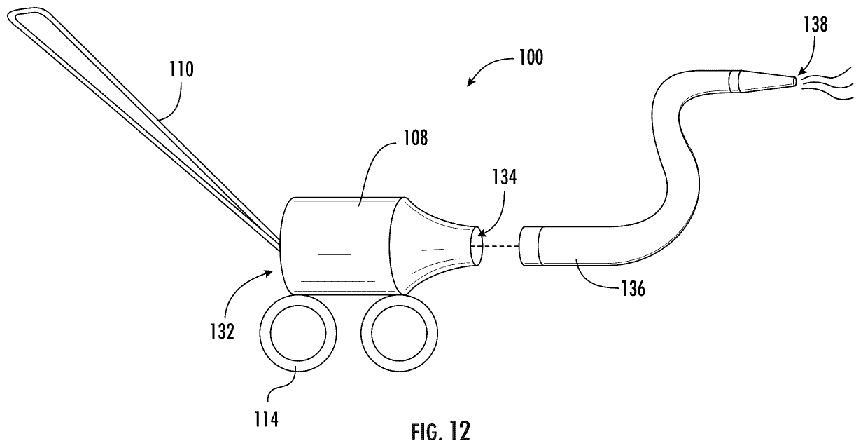

As an example, and turning especially to the embodiments of FIGS. 1, 8A, 8B, and 12, an elbow nozzle 136 may be attached to or included as part of the housing 108. For instance, the housing 108 may include a rigid main body 162 and an elbow segment or nozzle 136 that is movably (e.g., rotatably) mounted to the rigid main body 162. In particular, the elbow nozzle 136 may be attached on the second end 134 in downstream fluid communication with the airflow conduit 130. Thus, the elbow nozzle 136 may be downstream from the second end 134 to direct airflow therefrom. In some embodiments, the elbow nozzle 136 defines an elbow outlet 138 non-parallel to the second end 134. The angle of the elbow outlet 138 relative to the second end 134 (or longitudinal axis A_{L} of the airflow conduit 130) may be greater than 0° and less than 180° (e.g., around 90°). Optionally, the angle of the elbow outlet 138 relative to the second end 134 may be fixed, as shown in FIGS. 1, 8A, and 8B. Alternatively, the angle of the elbow outlet 138 relative to the second end 134 may be selectively variable, such as is illustrated in FIG. 12, wherein the elbow nozzle 136 includes or is provided as a flexible hose or “air noodle.” In either case, the elbow nozzle 136 may be affixed to the rigid main body 162 or, alternatively, selectively attachable/removable therefrom (e.g., as would be understood). Notably, the flexible hose may include a tapered nozzle to focus the airflow from the blower 100 (e.g., for use in smaller spaces or areas requiring more detailed airflow control). Optionally, the walking element(s) 114 may be disposed (e.g., partially or fully) rearward from the nozzle 136.

In some embodiments, the elbow nozzle 136 may be rotatably mounted to the rigid main body 162. As shown, the elbow nozzle 136 may be rotatably mounted on the frame 102 (e.g., via the rigid main body 162) to rotate about a pivot axis A_{P} that is axisymmetric (e.g., perpendicular) to an exhaust at the second end 134. For instance, the elbow nozzle 136 may be rotatably mounted to the housing 108 to rotate about second end 134 of the airflow conduit 130. Thus, the angle of the elbow outlet 138 relative to the second end 134 may be variable. For instance, in embodiments wherein the exhaust of the second end 134 is parallel to the transverse direction T (or the airflow path 160 from the second end 134 extends generally forward from the second end 134), the angle of the elbow outlet 138 relative to a horizontal direction may be variable, as illustrated in FIG. 8A. Additionally or alternatively, if the longitudinal axis A_{L} is parallel to the vertical direction V (or the airflow path 160 from the second end 134 extends generally extends downward), the angle of the elbow outlet 138 about the vertical direction V may be variable, as illustrated in FIG. 8B.

In certain embodiments, the airflow from the housing 108 or nozzle 136 can be selectively redirected (e.g., via rotation of nozzle) by a discrete remote-control input (e.g., in mechanical or electrical communication with an assembly to rotate the nozzle 136), which may be mounted to a handle assembly 110. For instance, an mechanical drivetrain; which may include one or more gears, pulleys, etc.; may connect a mechanical input device (e.g., mechanical handle, lever, slider, knob, or wheel) in mechanical communication with the drivetrain to direct rotation of the elbow nozzle 136 in tandem with movement of the mechanical input device. Additionally or alternatively, an electromechanical positional motor 104c may be attached to (or otherwise in mechanical communication with) the elbow nozzle 136 and in electrical communication with an electrical input device (e.g., electrical button, switch, joystick, slider, knob, or wheel), such as via the controller 150, such that the positional motor is directed to rotate or reposition the elbow nozzle 136 in response to an input signal received from the electrical input device.

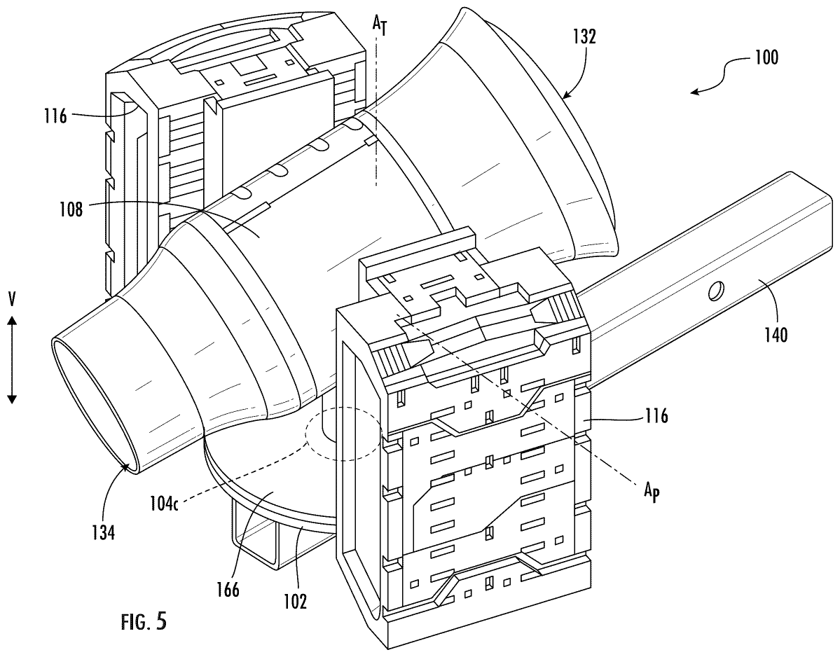

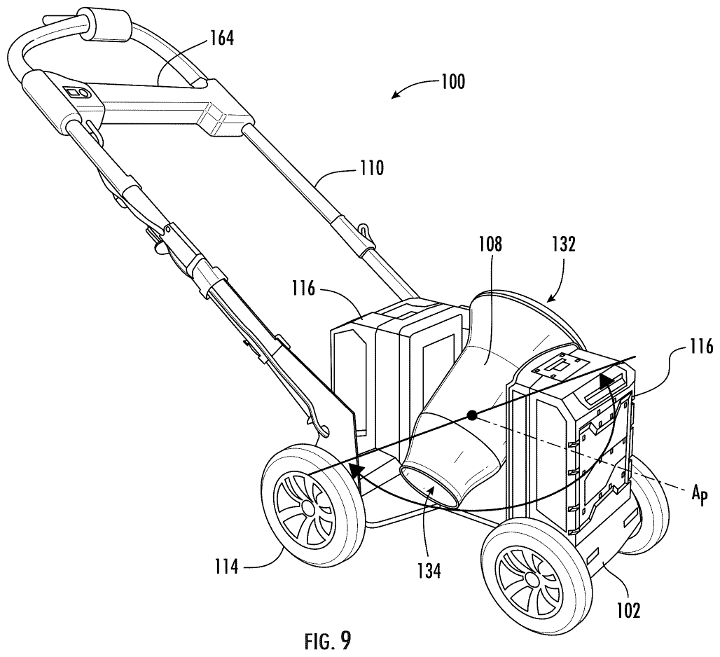

As an example, and turning especially to the embodiments of FIGS. 4, 5, and 9 the housing 108 may include a rigid main body 162 that defines the first end 132 and the second end 134 and is rotatable as a whole. Specifically, the rigid main body 162 may be rotatably mounted on the frame 102 to rotate about a pivot axis A_{P} that is axisymmetric (e.g., perpendicular) to an exhaust at the second end 134. Thus, in order to redirect the direction of the airflow relative to the frame 102, the entire rigid main body 162 may be rotated. The rotation may result in a flipping motion (e.g., such that the second end 134 is directed temporarily downward) as the rigid main body 162 moves the direction of airflow from one (e.g., lateral) side of the frame 102 to the other (e.g., lateral) side. In some embodiments, such as those shown in FIGS. 4 and 9, the pivot axis A_{P} is fixed relative to the frame 102. In turn, flipping the position of the rigid main body 162 may be set to alternate the direction of airflow (e.g., the side of the blower 100 from which the airflow is exhausted), such between a first lateral side and a second lateral side of the blower 100. In other embodiments, such as those illustrated at FIG. 5, a turret base 166 may support the housing 108 (e.g., including the rigid main body 162) on the frame 102. Separate from (e.g., in the absence of) or in addition to the pivot axis A_{P}, the turret base 166 may define a turret axis A_{T} (e.g., parallel to the vertical direction V) about which the housing 108 may rotate. The housing 108 may thus be rotatable about the turret axis A_{T} (e.g., by at least 360° or along a predefined arc less than 360°) with or without an additional pivot axis A_{P} to redirect the direction of the airflow relative to the frame 102. In optional embodiments, the turret base 166 and turret axis A_{T} are provided in addition to the pivot axis A_{P} such that the pivot axis A_{P} is movable relative to the frame 102, thereby increasing the degrees of freedom of movement for the housing 108 or airflow relative to the frame 102.

The airflow from the housing 108 can be selectively redirected (e.g., via rotation of nozzle) by a discrete remote control input (e.g., in mechanical or electrical communication with an assembly to rotate the housing 108), which may be mounted to the handle assembly 110. For instance, an mechanical drivetrain; which may include one or more gears, pulleys, etc.; may connect a mechanical input device (e.g., mechanical handle, lever, slider, knob, or wheel) in mechanical communication with the drivetrain to direct rotation of the housing 108 (e.g., about the pivot axis A_{P} or turret axis A_{T}) in tandem with movement of the mechanical input device. Additionally or alternatively, one or more electromechanical positional motors 104c may be attached to (or otherwise in mechanical communication with) the housing 108 and in electrical communication with an electrical input device (e.g., electrical button, switch, joystick, slider, knob, or wheel), such as via the controller 150, such that the positional motor(s) is/are directed to rotate or reposition the housing 108 about the pivot axis A_{P} or turret axis A_{T} in response to an input signal received from the electrical input device.

As noted above, battery compartment 112 can be attached to the frame 102 (e.g., apart or rearward from the first end 132) to receive one or more batteries or battery packs 116. In some embodiments, a plurality of batteries (i.e., two or more battery packs 116) thus are attached to the frame 102 (e.g., via the battery compartment 112) in electric communication with the fan assembly 106, propulsion motor 104b, or positional motor 104c. As shown in FIG. 4, the battery compartment 112 (and thus the received battery packs 116) may be disposed reward from the housing 108). Alternatively, the battery compartment 112 may span or extend to opposite sides of the housing 108 (e.g., such that the housing 108 is held between multiple received battery packs 116), as shown in FIGS. 5 and 9. Optionally, two battery packs 116 may be located in opposing directions (i.e., on opposite sides) of a central wall of the battery compartment. Additionally or alternatively, a major surface of each battery pack 116 may, when received on or within the battery compartment, in a shared plane that is defined as a vertical-fore-aft plane (e.g., as shown. The received battery packs 116 may be connected in series, parallel, or selectively isolated from a common circuit for sequential discharge.

In some embodiments, such as those illustrated by FIG. 4, a roll cage 168 may extend over at least a portion of the housing 108 (e.g., forward from the battery compartment 112). In turn, the roll cage 168 (e.g., with or without a grab handle 170 disposed on the battery compartment 112) may advantageously provide a pick point for users to lift the blower 100 up with a crane or for multiple people to pick it up and place it, as an example, in the back of a truck (e.g., in addition to providing roll protection to the housing 108).

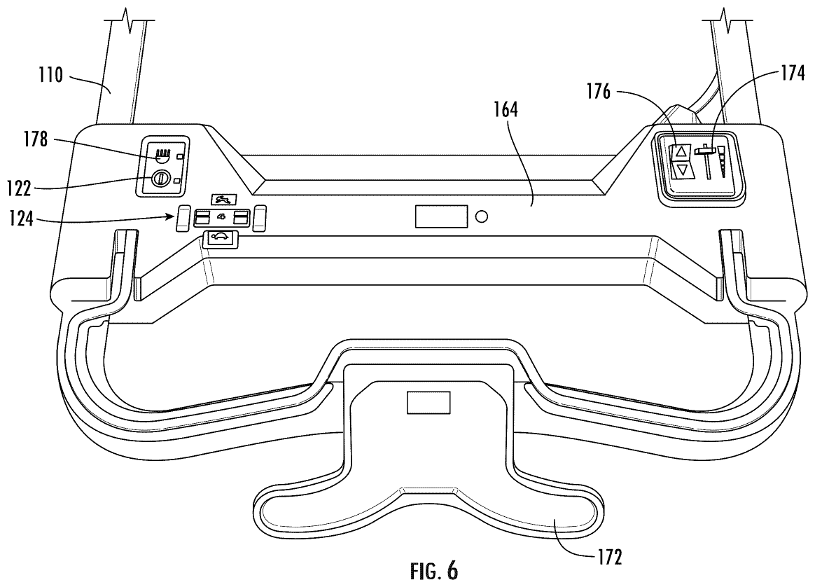

Turning now especially to FIG. 6, as well as FIG. 1, FIG. 6 provides a forward-facing perspective view of a user interface of a walk-behind blower 100, such as illustrated in FIG. 1. As noted above, the handle assembly 110 can extend from a rear end of the frame 102 and include one or more controls associated with controlling operational aspect(s) of the walk-behind blower 100, and which may be in electrical communication with the controller 150. Some such controls may be provided on an interface board 164 mounted to handle assembly 110. In some embodiments, the controls include one a power button 122 (e.g., to wake or activate controller 150 or motors 104a, 104b, 104c). A speed input 124 may be provided to selectively adjust or vary the self-propel speed setting of the propulsion motor 104b. Optionally, a self-propel activation lever 172 may be provided (e.g., rearward from the interface board 164 on the grip portion of the handle assembly 110 to selectively activate or deactivate the propulsion motor 104b. Additionally or alternatively, an airspeed input 174 may be provided to selectively adjust or vary the airflow speed setting of the fan motor 104c. Further additionally or alternatively, a blower input 176 may be provided to selectively adjust the position of the airflow (e.g., elbow nozzle 136 or housing 108) relative to the frame 102 (e.g., mechanically or, alternatively, via the positional motor 104c). Yet further controls may be provided, such as a lighting input 178 (e.g., for activating or deactivating a lighting assembly 184) or a dead-man's bail, as would be understood.

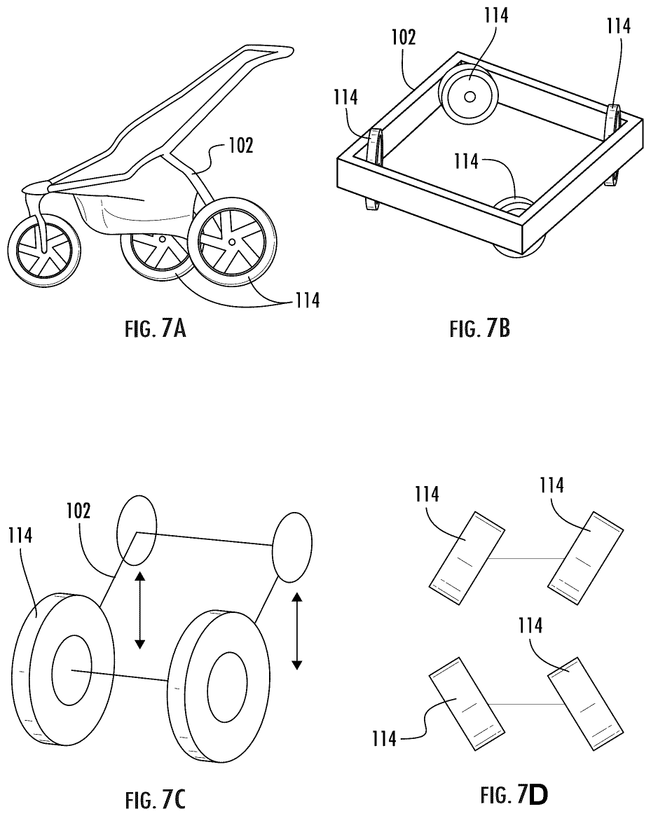

Turning especially to FIGS. 7A through 7D, as well as FIG. 1, FIGS. 7A through 7D provide schematic views of potential wheel arrangements for supporting the frame 102. In other words, various embodiments of movable elements to support the frame 102 (e.g., to be motivated for travel of the walk-behind blower 100 by the propulsion motor 104b) are shown.

As an example, and as particularly illustrated in FIG. 7A, the wheel arrangement may be provided as a three-wheel arrangement whereby a front caster wheel is positioned forward from a pair of rear wheels (e.g., driven wheels 114). The housing 108 (FIG. 1) may be supported between the three wheels (e.g., along the transverse direction T).

As another example, and as particularly illustrated in FIG. 7B, the wheel arrangement may include a plurality of omni-directional wheels 114. Such wheels may provide discs around the circumference of a base wheel, the discs being perpendicular to the turning direction of the base wheel, similar to those included in holonomic drive systems, as would be understood. The housing 108 (FIG. 1) may be supported (e.g., centrally in a horizontal plane relative to the omni-directional wheels.

As yet another example, and as particularly illustrated in FIG. 7C, the wheel arrangement may be provided as a four-wheel arrangement having a front pair and a rear pair of wheels 114. Optionally, the rear pair of wheels 114 may be fixed-axis driven wheels in mechanical communication with the propulsion motor 104b (FIG. 1). The front pair of wheels may be fixed-axis wheels (e.g., requiring a user to tilt the blower 100 or otherwise lift the front pair of wheels off the ground for turning) or, alternatively, pivotable (e.g., caster) wheels.

As still another example, and as particularly illustrated in FIG. 7D, the wheel arrangement may be provided as a four-wheel, dual-steer arrangement. In such an arrangement, a front pair and a rear pair of wheels 114 may be included. As would be understood, each pair of wheels may have a separate yaw axis about which the corresponding pair of wheels can tilt (e.g., as such wheels rotate). An opposite direction of tilt may thus facilitate a smaller or tighter turning radius than would otherwise be possible (e.g., in an embodiment wherein one or both of the front and rear wheel pairs are fixed-axis wheels).

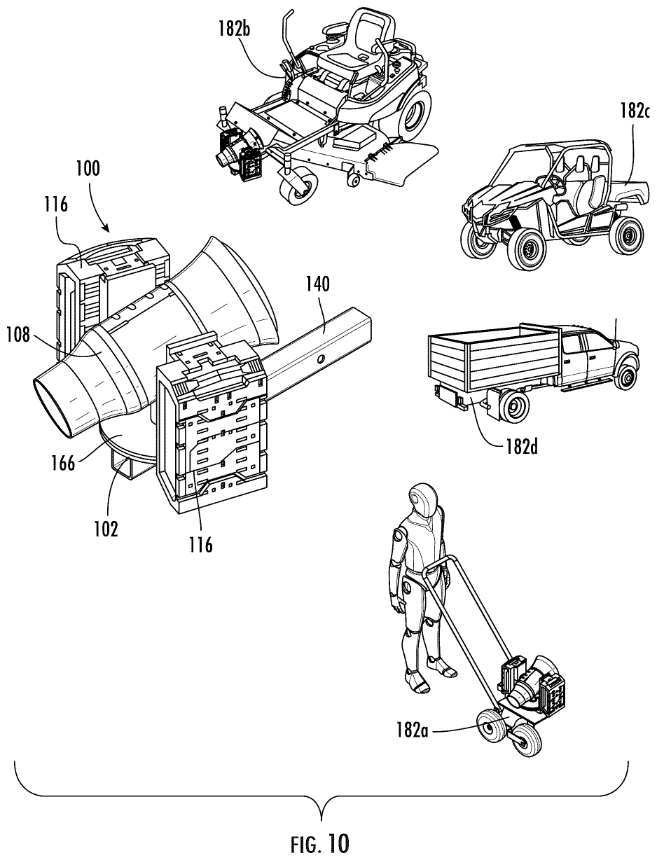

Referring now especially to FIG. 10, some embodiments permit the selective attachment of the frame 102 and housing 108 to a plurality of interchangeable support structures or vehicles. For instance, the frame 102 may define a coupling arm 180 by which the frame 102 (and thereby housing 108) may attach to separate structures or vehicles. Such coupling arm 180s may generally be understood in light of the present disclosure, and may be embodied similar to a hitch connection on a typical light-duty truck. Although the present disclosure is not limited to any particular support structure, such may include a dedicated (e.g., manual or self-propelled) dolly 182a, ZTR mower 182b, utility vehicle 182c (e.g., tractor, ATV, riding lawnmower, etc.), or truck 182d.

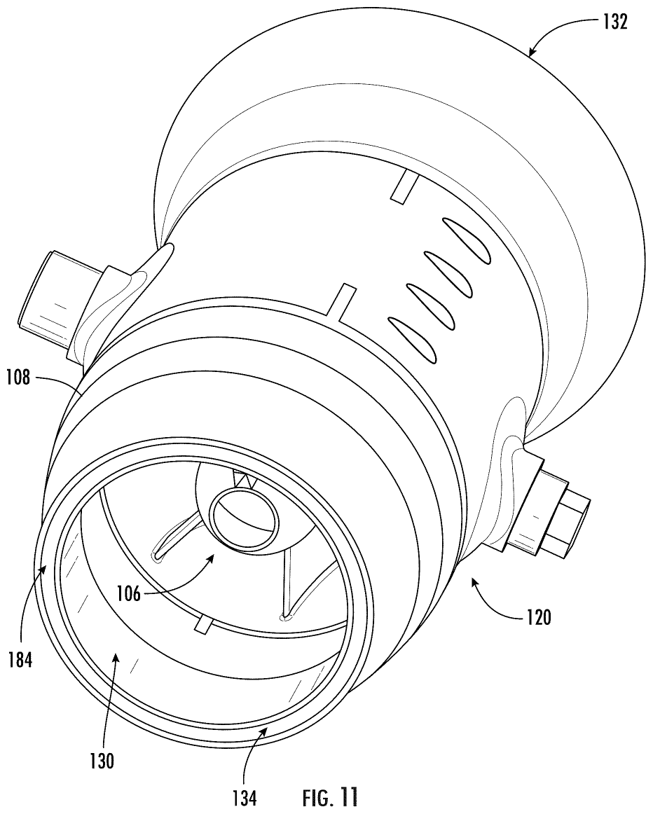

Turning now to FIG. 11, as well as FIG. 1, FIG. 11 provides a perspective view of a fan assembly and housing 108 of a walk-behind blower 100, including a lighting assembly 184 therein. Generally, the walk-behind blower 100 can include one or more lighting elements (e.g., one or more light emitting diodes, commonly referred to as LEDs) configured to illuminate one or more areas of the environment in which the walk-behind blower 100 is operating. For example, the walk-behind blower 100 can include one or more lighting assemblies 184 (e.g., including one or more light emitting diodes, fluorescent bulbs, halogen bulbs, incandescent bulbs, etc.) disposed on the fan housing 108. The light can be disposed on a front portion of the fan housing 108 so as to illuminate an area in front of the walk-behind blower 100 during operation (e.g., an area or debris to be treated with the walk-behind blower 100). For instance, and as illustrated especially at FIG. 11, the lighting assembly 184 may include or be provided as a ring assembly disposed on the housing 108 adjacent to (e.g., radially outward from or about) at least a portion of an exhaust defined at the second end 134 (e.g., to illuminate a region in the direction of the airflow from the exhaust). Additionally or alternatively, the walk-behind blower 100 can include one or more light or light units (e.g., including one or more light emitting diodes, fluorescent bulbs, halogen bulbs, incandescent bulbs, etc.) configured to illuminate a path cleared by the walk-behind blower 100. For instance, the light unit(s) can be mounted on the handle assembly 110 or any other suitable location to illuminate in a direction rearward from a path cleared by the fan assembly 120.

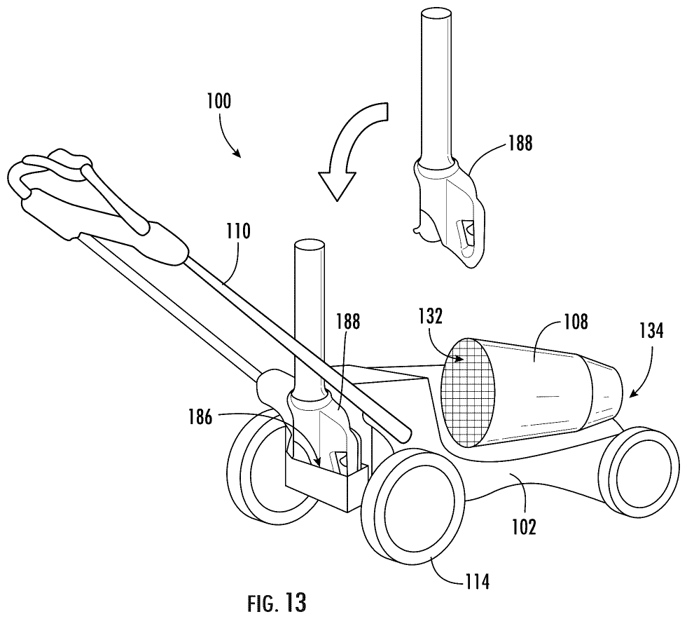

Turning now to FIG. 13, a simplified schematic view of a walk-behind blower 100 and selectively attachable hand-held blower 188 is provided. As shown, the frame 102 may include or define a blower dock 186 to receive a separate hand-held blower 188 that is operable independent of the blower 100. Such a blower dock 186 may, for instance, define a pocket, recess, mating rail or slot into which a portion of the hand-held blower 188 may be inserted and supported within. As would be understood, additional or alternative securing elements may be provided to ensure that the hand-held blower 188 is held in place relative to the frame 102, even while the blower 100 operates.

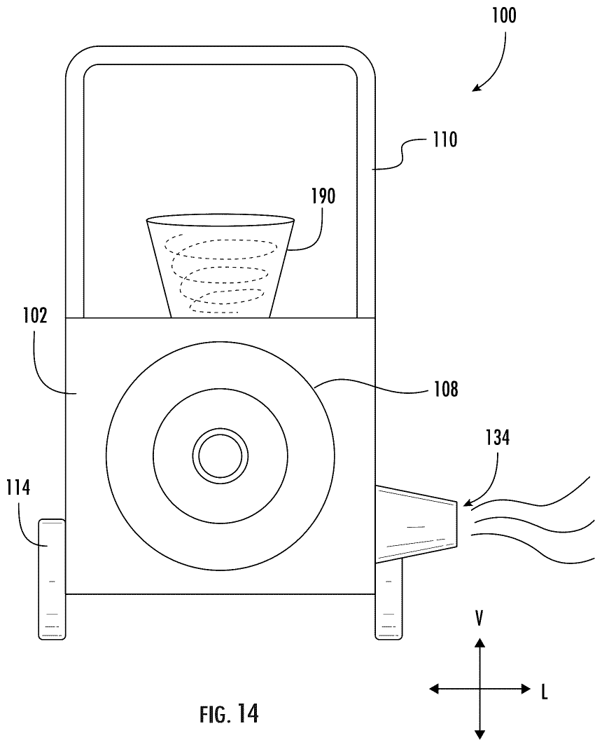

Turning now to FIG. 14, a simplified schematic view of a walk-behind blower 100 is provided. As shown, an additive hopper 190 may be mounted to the housing 108 (e.g., at an upper portion thereof). When assembled, the additive hopper 190 may be in fluid communication with the airflow conduit 130 between the first end 132 and the second end 134. Generally, the additive hopper 190 may receive or hold a fluid or particulate additive material (e.g., salt, fertilizer, seed, insecticide, herbicide, or water) to be delivered and mixed or entrained with the airflow through the housing 108. Thus, the additive hopper 190 may be upstream from the exhaust at the second end 134 of the housing 108 to deliver an additive material to the airflow prior to being exhausted from the second end 134. Optionally, a selectively openable door or valve may be mounted between the particulate chamber defined by the hopper 190 and the airflow conduit 130 defined by the housing 108. In turn, and as would be understood, the additive material may be selectively released to the airflow conduit 130 (FIG. 1) (e.g., according to a set program or manual user input). Moreover, the walk-behind blower may be selectively operable to act as a spreader, fogger, or mister.

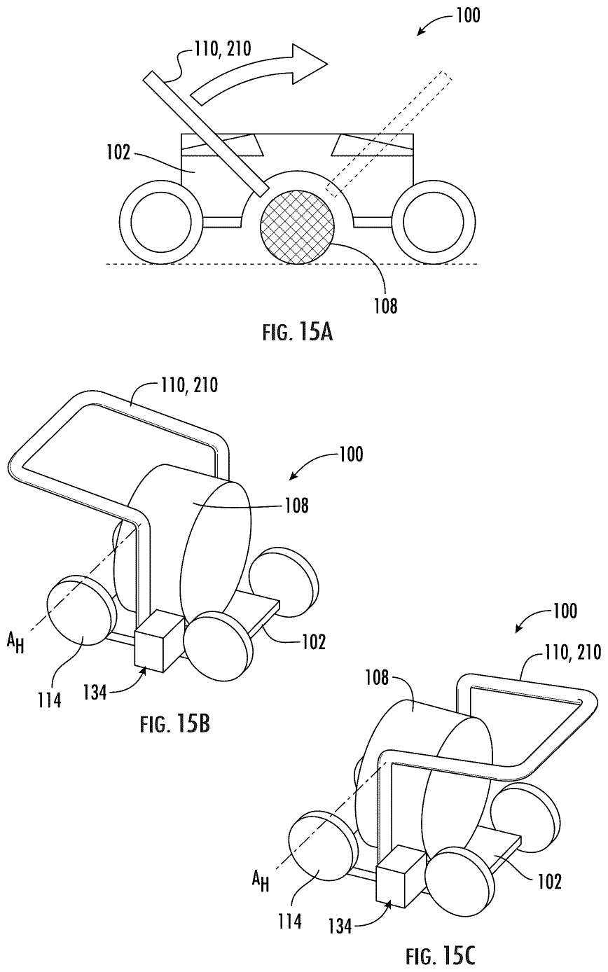

Turning now especially to FIGS. 15A through 15C, simplified views are provided of various embodiments having a movable handle assembly 210. In some embodiments, the handle assembly 110 includes or is provided as the handle assembly 210 having a pivotable handle that is attached to the frame 102. Specifically, the pivotable handle may be movably mounted such that a lateral pivot axis A_{H} is defined for pivoting movement of the handle (i.e., pivoting movement of the grip portion of the handle, which may be defined at a free end 214 of the handle assembly 210). When assembled, the pivotable handle may be movable between a (e.g., predetermined) first and second position. At the first position (e.g., FIG. 15B), the pivotable handle of the movable handle assembly 210 may extend generally perpendicular to the lateral direction away from a first (e.g., rear) end of the walk-behind blower 100. For instance, along at least a portion of the transverse direction T, the pivotable handle may extend rearward from the frame 102 (e.g., such that the grip portion of the handle assembly 210 is disposed rearward from a rearmost edge of the frame 102). By contrast, at the second position (e.g., FIG. 15C), the pivotable handle may extend perpendicular to the lateral direction away from a second (e.g., front) end of the walk-behind blower 100. For instance, along at least a portion of the transverse direction, the pivotable handle may extend forward from the frame 102 (e.g., such that the grip portion of the handle assembly 210 is disposed forward from the foremost edge of the frame 102). Thus, a user may be able to push or walk behind the blower from opposite transverse ends of the blower (e.g., to guide the blower along parallel rows without turning the frame 102 or walking backwards, for instance while still pushing leaves or particular in the same general direction).

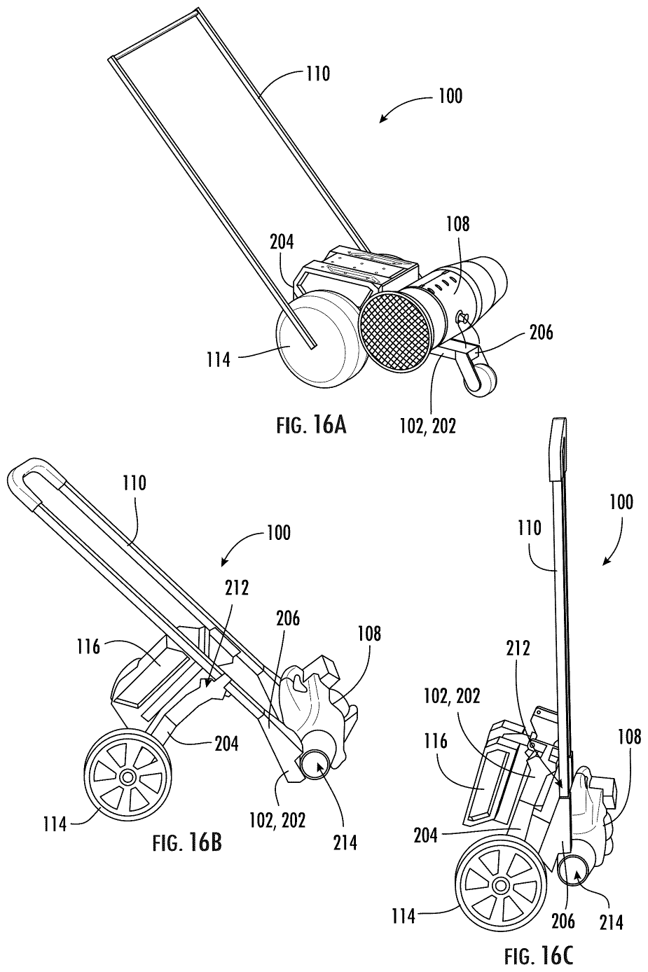

Turning now especially to FIGS. 16A through 16C, simplified views are provided of various embodiments having a foldable frame assembly 202. In certain embodiments, the frame 102 includes or is provided as a multi-piece assembly in which two or more segments are movably connected. For instance, the frame 102 may at least include a first segment 204 and a second segment 206 movably connected to the first segment 204. In some such embodiments, the first segment 204 and the second segment 206 are pivotably or slidably connected. The second segment 206 in particular may include or extend between a supported end 212 (e.g., at which the second segment 206 is connected to the first segment 204) and a free end 214 (e.g., distal to the connection with the first segment 204). When assembled, the frame 102 may be movable between an extended position (e.g., FIG. 16A) and a folded position (e.g., FIG. 16C), which may facilitate compact storage of the walk-behind blower 100. At the extended position, the free end 214 of the second segment 206 may be held distal to the first segment 204 (e.g., such that a relatively large footprint or length of the frame 102 along the transverse direction is defined). By contrast, at the folded position, the free end 214 may be held proximal to the first segment 204 (e.g., such that a relatively small footprint or length of the frame 102 along the transverse direction is defined).

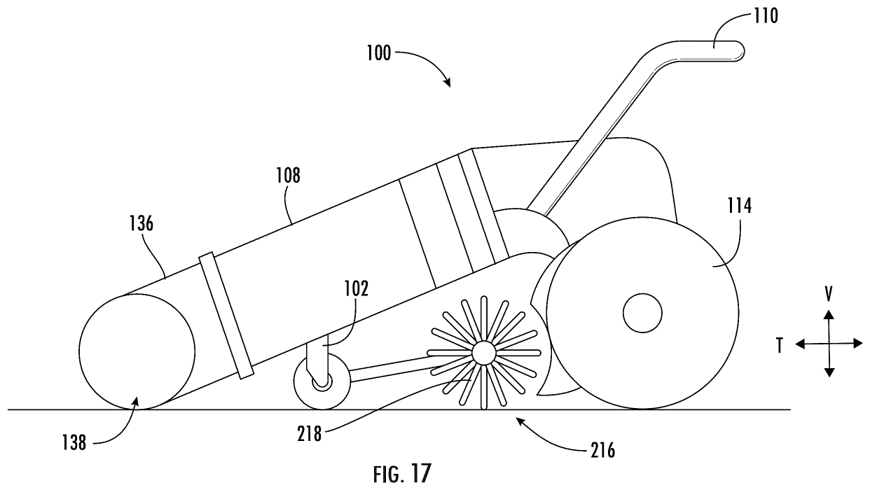

Turning now especially to FIG. 17, a simplified schematic view of an exemplary embodiments of walk-behind blower 100 including a sweeper assembly 216. In some embodiments, the sweeper assembly 216 may include a rotatable sweeper brush 218 disposed proximal to the ground surface (or support plane defined by the walking elements). As shown, the rotatable sweeper brush 218 may be disposed rearward from one or more of the walking elements (e.g., between the front wheels and rear wheels along the transverse direction T). Additionally or alternatively, the sweeper brush 218 may be disposed rearward from the second end 134 of the housing 108 or exhaust thereof. Optionally, a collection bin may further be disposed rearward from the sweeper brush 218. During use, the sweeper brush 218 may engage the ground behind the airflow exhaust to agitate and propel residual debris or particulate rearward (e.g., to the collection bin) to remove debris or particulate (e.g., leaves) not blown by the airflow from the housing 108.

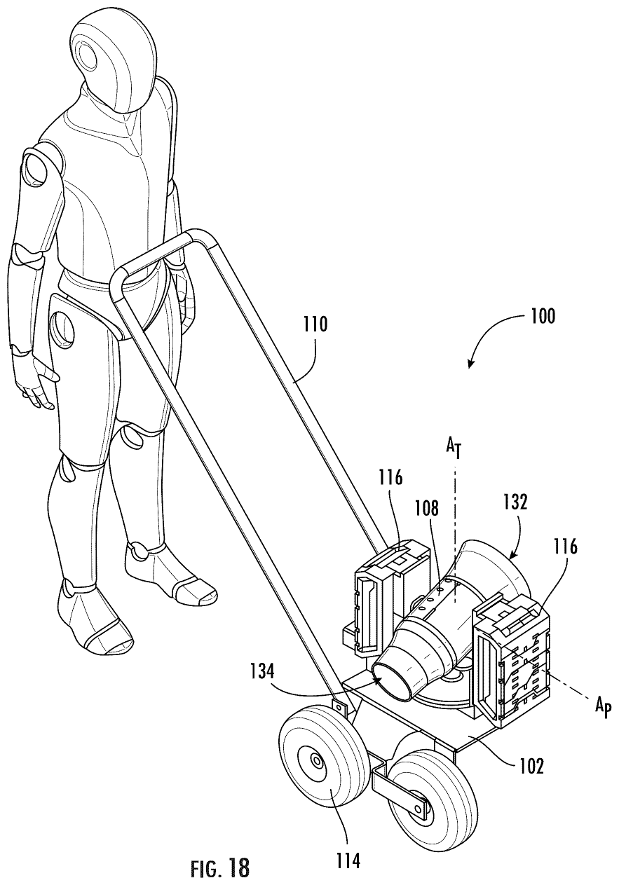

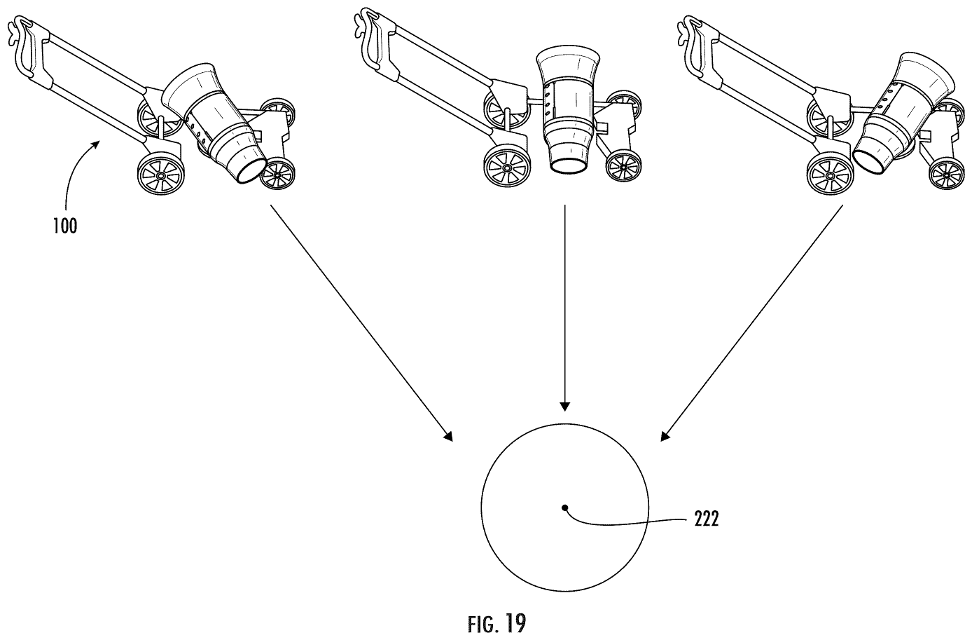

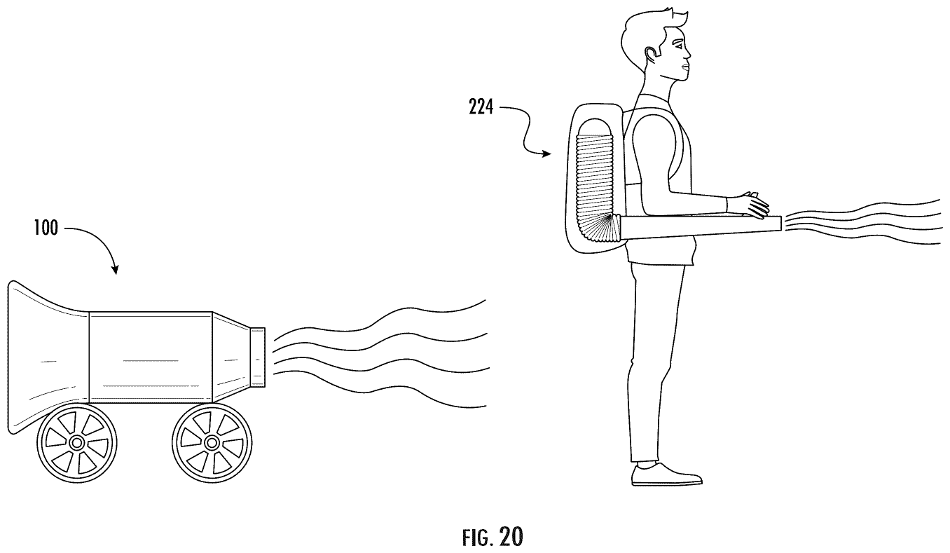

Turning now especially to FIGS. 1 and 18 through 20, in some embodiments, controller 150 is particularly configured (e.g., programmed) to direct operation of blower 100 (e.g., according to one or more predetermined blower operations or algorithms). In particular, controller 150 may be configured to direct fan motor 104a, propulsion motor 104b, or positional motor 104c according to a programmed blower operation.

As an example, the blower operation (soft-start operation) may direct rotation of the fan motor 104a at a set or selected velocity. Optionally, controller 150 may be configured to direct a progressive fan velocity. The progressive fan velocity may gradually increase a target rotational velocity at the fan motor 104a (e.g., from a static state). Thus, the progressive fan velocity may determine the fan motor 104a is at a static (e.g., stopped or unpowered) state such that airflow is not being motivated at the blower fan 106. Subsequently, the controller 150 may receive an activation signal (e.g., from the power button 122, speed input 124, or one or more other controls) and determine an operational target speed for the fan motor 104a. The controller 150 may then set one or more intermediate target speeds between 0 and the operational target speed. In turn, the fan motor 104a may be progressively directed to the one or more intermediate target speeds (e.g., according to a predetermined pattern or interval), increasing the target speed until the operational target speed is met. Upon being met, the motor 104a may continue at the operational target speed (e.g., indefinitely, such as until battery power is fully dissipated, a halt-rotation signal is received, or a user otherwise directs the fan assembly 120 to stop). Notably, a soft-start velocity ramping of the fan assembly 120 may be achieved.

As an additional or alternative example, the blower operation (e.g., coast operation) may selectively vary blower velocity based on rotation of the exhaust (e.g., 134 or 138). In such embodiments, the exhaust can rotate (e.g., between two lateral sides of the blower 100, as described above) along a predefined rotation path between two path ends. Between the two path ends, the rotation path may include a vertically facing point at which the exhaust is directed generally vertically (e.g., downward or otherwise toward a support surface). At either path end—or otherwise at a point apart from the vertically facing point—the blower operation may direct the fan motor 104a to rotate at an operational target speed. During rotation between the two path ends, however, the fan motor 104a may be directed to a reduced target speed that is less than the operational target speed (e.g., between 0 and the operational target speed). Thus, in response to moving the housing 108 from one path end or to the vertically facing point, the fan motor 104a may be slowed from the operational target speed to the reduced target speed. In response to reaching the opposite path end or leaving the vertically facing point, the fan motor 104a velocity may be increased to the operational target speed. Upon being met, the motor 104a may continue at the operational target speed (e.g., indefinitely, such as until battery power is fully dissipated, a halt-rotation signal is received, subsequent rotation of housing 108, or a user otherwise directs the fan assembly 120 to stop). Notably, stalling of the fan assembly 120 may be prevented or a user may avoid an upward or tilting force to the blower.

As another additional or alternative example, the blower operation (e.g., flip operation) may selectively direct activation or rotation of the positional motor 104c based on one or more directional input signals. In such embodiments, the (e.g., 134 or 138) can rotate (e.g., between two lateral sides of the blower 100, as described above) as directed by the positional motor 104c along a predefined rotation path between two path ends. Optionally, receipt of a directional input signal may initiate activation of the positional motor 104c such that the housing 108 or exhaust is flipped or otherwise moved from one path end to the opposite path end. Generally, the directional input signal may include a signal indicating such a flip should be performed. For instance, the directional input signal may include a user-initiated signal, such as might be received from the interface board 164 or a corresponding control input. Additionally or alternatively, the directional input signal may include an automated sensor signal received from a predetermined sensor mounted to the motor, such as a compass, accelerometer, or gyroscope. In some such embodiments, turning or redirecting the blower (e.g., 180° or 90° about a vertical axis) can prompt the housing 108 or exhaust to flip or otherwise move from one path end to the opposite path end.

Notably, in a case where the user is blowing leaves from a yard, row by row, it may be beneficial to use the flip operation when going back and forth along the rows, blowing in a consistent direction. Additionally or alternatively, it may be beneficial to have a hold row heading feature where the tool senses it is entering a 180° degree turn and initiates a flip to maintain the same direction of the blower as the previous row. The heading could also be maintained through the use of a compass in which a direction (e.g., compass direction, such as in degrees relative to North, South, East, or West) is input by the user, and the blower looks to maintain that heading and flip when the direction of travel is about 90° degrees offset from the user-set heading.

As another additional or alternative example, the blower operation (e.g., target operation) may selectively direct activation or rotation of the positional motor 104c based on one or more target input signals. In such embodiments, the (e.g., 134 or 138) can rotate generally (e.g., about the pivot axis A_{P} or turret axis A_{T}) as directed by the positional motor 104c along one or more predefined rotation paths. Thus, the positional motor 104c may selectively redirect the air conduit 130 according to the defined target 222. Optionally, receipt of a target input signal may initiate activation of the positional motor 104c such that the housing 108 or exhaust is moved (e.g., redirected continuously or according to a set interval, pattern, or sequence) to a defined target 222. Generally, the target input signal may include a signal indicating the location of the defined target 222 and, thus, the intended direction of airflow from the blower 100. The target signal may include a passive target signal (e.g., received in response to a target request or output from the blower) or active target signal (e.g., received from the defined target 222). For instance, the target signal may include an image or infrared reading captured at the controller 150. The controller 150 may be configured to identify the target (e.g., as a user, heat source, or passive beacon). Additionally or alternatively, the target signal may include a radio-frequency (RF) signal [e.g., ultra-wideband (UWB) signal] transmitted from and by the defined target 222. Further additionally or alternatively, the target signal may include a global positioning satellite (GPS) signal input by a user or transmitted from the defined target 222. It is noted that although specific examples are given herein, it would be understood that any suitable target tracking for a static or mobile target may be used to provide a target input signal at the blower for the purpose of determining the location of the defined target 222 as the blower 100 moves along the ground.

Notably, in a case in which the user wants to blow leaves onto a single point (e.g., tarp) or in the direction of one or more individuals (e.g., using handheld or backpack blowers to agitate leaves or debris). The positional motor 104c may then adjust the housing 108 or exhaust towards the defined target 222 as the blower 100 moves or is moved along the ground.

As another additional or alternative example, the blower operation (e.g., follow operation) may selectively direct activation or rotation of the propulsion motor 104b based on one or more movement input signals. In such embodiments, the walking elements as directed by the propulsion motor 104b along the ground toward or according an identified mobile target 224. Thus, the propulsion motor 104b may selectively move the blower 100 according to the identified mobile target 224. Generally, the movement input signal may include a signal indicating the location of the identified mobile target 224 and, thus, the intended position of the blower 100. The target signal may include a passive target signal (e.g., received in response to a target request or output from the blower) or active target signal (e.g., received from the defined target 222). For instance, the target signal may include an image or infrared reading captured at the controller 150. The controller 150 may be configured to identify the target (e.g., as a user, heat source, or passive beacon). Additionally or alternatively, the target signal may include a radio-frequency (RF) signal [e.g., ultra-wideband (UWB) signal] transmitted from and by the defined target 222. Further additionally or alternatively, the target signal may include a global positioning satellite (GPS) signal input by a user or transmitted from the defined target 222. It is noted that although specific examples are given herein, it would be understood that any suitable target tracking for a static or mobile target may be used to provide a movement input signal at the blower for the purpose of determining the location of the defined target 222 as the blower 100 moves along the ground.

Notably, in a case in which the user wants to follow one or more individuals (e.g., using handheld or backpack blowers to agitate leaves or debris). The propulsion motor 104b may then move the blower 100 along the ground as the identified mobile target 224 moves.

The business is particularly interested in reviewing claims related to an autonomous or robotic blower. The provisional mentions at a very high level that the blower may be autonomous so the application would benefit from mentioning the blower is capable of being an autonomous, remote controlled, or robotic blower but we would like to keep from adding in new content in this application and would prefer to handle new content as a separate invention. In one case, the walk-behind blower 100 may have an autonomous mode where it can operate a predefined or trained path.

In light of the present disclosure, it would further be understood that the blower operation may include or be provided as an autonomous mode in which one or more motors 104a, 104b, 104c or one or more further features are autonomously directed or activated without direct input, presence, or guidance from a user. Additionally or alternatively, it would further be understood that the blower operation may include or be provided as a remote-control mode in which one or more motors 104a, 104b, 104c or one or more further features are directed or activated according to one or more signals received from a remote device (e.g., dedicated fob, computer, tablet, smartphone, server, etc.) without direct physical input, presence, or guidance from a user at the blower 100.

Further aspects of the disclosure are provided by one or more of the following embodiments:
Embodiment 1. A walk-behind blower comprising: a frame; one or more movable elements mounted to the frame to movably support the frame; a housing supported on the frame, the housing defining an airflow conduit extending therethrough between a first end and a second end, at least a portion of the housing being movable relative to the frame to selectively redirect an airflow from the airflow conduit; and a fan assembly disposed between the first end and the second end to motivate the airflow through the airflow conduit.
Embodiment 2. The walk-behind blower of any one or more of the embodiments, further comprising a plurality of batteries attached to the frame in electric communication with the fan assembly.
Embodiment 3. The walk-behind blower of any one or more of the embodiments, further comprising a propulsion motor in mechanical communication with the one or more movable elements to motivate travel of the walk-behind blower.
Embodiment 4. The walk-behind blower of any one or more of the embodiments, wherein the housing comprises a rigid main body and an elbow segment rotatably mounted to the rigid main body, wherein the elbow segment defines a curved portion of the airflow conduit offsetting the first end from the second end, and wherein the elbow segment defines the second end as an exhaust of the housing.
Embodiment 5. The walk-behind blower of any one or more of the embodiments, wherein the housing comprises a rigid main body defining the first end and the second end, and wherein the rigid main body is rotatably mounted on the frame to rotate about a pivot axis axisymmetric to an exhaust at the second end.
Embodiment 6. The walk-behind blower of any one or more of the embodiments, further comprising a ring assembly disposed on the housing about an exhaust defined at the second end to illuminate a region in a direction of the airflow from the exhaust.
Embodiment 7. The walk-behind blower of any one or more of the embodiments, wherein the frame defines a blower dock to receive a hand-held blower thereon.
Embodiment 8. The walk-behind blower of any one or more of the embodiments, further comprising an additive hopper mounted to the housing in fluid communication with the airflow conduit between the first end and the second end to deliver an additive material to the airflow prior to being exhausted from the second end.
Embodiment 9. The walk-behind blower of any one or more of the embodiments, further comprising a pivotable handle attached to the frame, the pivotable handle being movable about a lateral pivot axis between a first position and a second position, the first position extending the pivotable handle perpendicular to a lateral direction away from a first end of the walk-behind blower, and the second position extending the pivotable handle perpendicular to the lateral direction away from a second end of the walk-behind blower.
Embodiment 10. The walk-behind blower of any one or more of the embodiments, wherein the frame comprises a first segment and a second segment movably connected to the second segment, the second segment extending between a supported end and a free end, the frame being movable between an extended position holding the free end distal to the first segment and a folded position holding the free end proximal to the first segment.
Embodiment 11. The walk-behind blower of any one or more of the embodiments, further comprising a positional motor attached to the housing in mechanical communication with the housing to selectively redirect the air conduit according to a directional input signal.
Embodiment 12. The walk-behind blower of any one or more of the embodiments, further comprising a turret base supporting the housing on the frame, the housing being rotatable about a turret axis defined by the turret base.
Embodiment 13. The walk-behind blower of any one or more of the embodiments, further comprising a positional motor attached to the housing in mechanical communication with the housing to selectively redirect the air conduit according to a defined target.
Embodiment 14. The walk-behind blower of any one or more of the embodiments, further comprising a propulsion motor in mechanical communication with the one or more movable elements to motivate travel of the walk-behind blower; and a controller in electrical communication with the propulsion motor to direct movement of the walk-behind blower according to an identified mobile target.
Embodiment 15. A walk-behind blower comprising: a frame; one or more movable elements mounted to the frame to movably support the frame; a housing supported on the frame, the housing defining an airflow conduit extending therethrough between a first end and a second end, at least a portion of the housing being movable relative to the frame to selectively redirect an airflow from the airflow conduit; a propulsion motor in mechanical communication with the one or more movable elements to motivate travel of the walk-behind blower; a fan assembly disposed between the first end and the second end to motivate the airflow through the airflow conduit; a positional motor attached to the housing in mechanical communication with the housing to selectively redirect the air conduit according to a directional input signal; and a plurality of batteries attached to the frame in electric communication with the propulsion motor, the fan assembly, and the positional motor.
Embodiment 16. The walk-behind blower of any one or more of the embodiments, further comprising a ring assembly disposed on the housing about an exhaust defined at the second end to illuminate a region in a direction of the airflow from the exhaust.
Embodiment 17. The walk-behind blower of any one or more of the embodiments, further comprising an additive hopper mounted to the housing in fluid communication with the airflow conduit between the first end and the second end to deliver an additive material to the airflow prior to being exhausted from the second end.
Embodiment 18. The walk-behind blower of any one or more of the embodiments, further comprising a pivotable handle attached to the frame, the pivotable handle being movable about a lateral pivot axis between a first position and a second position, the first position extending the pivotable handle perpendicular to a lateral direction away from a first end of the walk-behind blower, and the second position extending the pivotable handle perpendicular to the lateral direction away from a second end of the walk-behind blower.
Embodiment 19. The walk-behind blower of any one or more of the embodiments, wherein the frame comprises a first segment and a second segment movably connected to the second segment, the second segment extending between a supported end and a free end, the frame being movable between an extended position holding the free end distal to the first segment and a folded position holding the free end proximal to the first segment.
Embodiment 20. The walk-behind blower of any one or more of the embodiments, further comprising a turret base supporting the housing on the frame, the housing being rotatable about a turret axis defined by the turret base.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A walk-behind blower comprising:
a frame;
one or more movable elements mounted to the frame to movably support the frame;
a housing supported on the frame, the housing defining an airflow conduit extending therethrough between a first end and a second end, at least a portion of the housing being movable relative to the frame to selectively redirect an airflow from the airflow conduit; and
a fan assembly disposed between the first end and the second end to motivate the airflow through the airflow conduit.

2. The walk-behind blower of claim 1, further comprising a plurality of batteries attached to the frame in electric communication with the fan assembly.

3. The walk-behind blower of claim 1, further comprising a propulsion motor in mechanical communication with the one or more movable elements to motivate travel of the walk-behind blower.

4. The walk-behind blower of claim 1, wherein the housing comprises a rigid main body and an elbow segment rotatably mounted to the rigid main body, wherein the elbow segment defines a curved portion of the airflow conduit offsetting the first end from the second end, and wherein the elbow segment defines the second end as an exhaust of the housing.

5. The walk-behind blower of claim 1, wherein the housing comprises a rigid main body defining the first end and the second end, and wherein the rigid main body is rotatably mounted on the frame to rotate about a pivot axis axisymmetric to an exhaust at the second end.

6. The walk-behind blower of claim 1, further comprising a ring assembly disposed on the housing about an exhaust defined at the second end to illuminate a region in a direction of the airflow from the exhaust.

7. The walk-behind blower of claim 1, wherein the frame defines a blower dock to receive a hand-held blower thereon.

8. The walk-behind blower of claim 1, further comprising an additive hopper mounted to the housing in fluid communication with the airflow conduit between the first end and the second end to deliver an additive material to the airflow prior to being exhausted from the second end.

9. The walk-behind blower of claim 1, further comprising a pivotable handle attached to the frame, the pivotable handle being movable about a lateral pivot axis between a first position and a second position, the first position extending the pivotable handle perpendicular to a lateral direction away from a first end of the walk-behind blower, and the second position extending the pivotable handle perpendicular to the lateral direction away from a second end of the walk-behind blower.

10. The walk-behind blower of claim 1, wherein the frame comprises a first segment and a second segment movably connected to the second segment, the second segment extending between a supported end and a free end, the frame being movable between an extended position holding the free end distal to the first segment and a folded position holding the free end proximal to the first segment.

11. The walk-behind blower of claim 1, further comprising a positional motor attached to the housing in mechanical communication with the housing to selectively redirect the air conduit according to a directional input signal.

12. The walk-behind blower of claim 1, further comprising a turret base supporting the housing on the frame, the housing being rotatable about a turret axis defined by the turret base.

13. The walk-behind blower of claim 1, further comprising a positional motor attached to the housing in mechanical communication with the housing to selectively redirect the air conduit according to a defined target.

14. The walk-behind blower of claim 1, further comprising a propulsion motor in mechanical communication with the one or more movable elements to motivate travel of the walk-behind blower; and
a controller in electrical communication with the propulsion motor to direct movement of the walk-behind blower according to an identified mobile target.

15. A walk-behind blower comprising:
a frame;
one or more movable elements mounted to the frame to movably support the frame;
a housing supported on the frame, the housing defining an airflow conduit extending therethrough between a first end and a second end, at least a portion of the housing being movable relative to the frame to selectively redirect an airflow from the airflow conduit;
a propulsion motor in mechanical communication with the one or more movable elements to motivate travel of the walk-behind blower;
a fan assembly disposed between the first end and the second end to motivate the airflow through the airflow conduit;
a positional motor attached to the housing in mechanical communication with the housing to selectively redirect the air conduit according to a directional input signal; and
a plurality of batteries attached to the frame in electric communication with the propulsion motor, the fan assembly, and the positional motor.

16. The walk-behind blower of claim 15, further comprising a ring assembly disposed on the housing about an exhaust defined at the second end to illuminate a region in a direction of the airflow from the exhaust.

17. The walk-behind blower of claim 15, further comprising an additive hopper mounted to the housing in fluid communication with the airflow conduit between the first end and the second end to deliver an additive material to the airflow prior to being exhausted from the second end.

18. The walk-behind blower of claim 15, further comprising a pivotable handle attached to the frame, the pivotable handle being movable about a lateral pivot axis between a first position and a second position, the first position extending the pivotable handle perpendicular to a lateral direction away from a first end of the walk-behind blower, and the second position extending the pivotable handle perpendicular to the lateral direction away from a second end of the walk-behind blower.

19. The walk-behind blower of claim 15, wherein the frame comprises a first segment and a second segment movably connected to the second segment, the second segment extending between a supported end and a free end, the frame being movable between an extended position holding the free end distal to the first segment and a folded position holding the free end proximal to the first segment.

20. The walk-behind blower of claim 15, further comprising a turret base supporting the housing on the frame, the housing being rotatable about a turret axis defined by the turret base.
